(19) United States
(12) Patent Application Publication
(10) Pub. No.: US 2013/0062841 A1
(43) Pub. Date: Mar. 14, 2013

(54) Off-road vehicle

(71) Applicant: James K. Bullis, Sunnyvale, CA (US)

(72) Inventor: James K. Bullis, Sunnyvale, CA (US)

(21) Appl. No.: 13/199,968

(22) Filed: Sep. 14, 2011

(51) Int. Cl. B62M 1/00; B60K 8/00; B62D 55/00

(52) U.S. Cl. 280/32.5; 280/28.5; 280/288.1; 180/54.1

(57) ABSTRACT

Invented are narrow vehicles for operation on soft surfaces for agricultural use. These would enhance worker productivity and make the work more attractive. It is essential that such vehicles be simple and low cost to enable wide adaptation.

Such vehicles include a frame and a wheel set that enables a low seating position for a rider. This low seat position changes requirements for stability compared to most, familiar vehicle types. The intended low speed operation further eases the requirement for stability measures.

The width of the vehicle is approximately the same width as the seated rider which enables vehicle use with narrowly spaced row crops. Wide drum wheels provide the needed stability, and with large diameter the drum has maximized footprint area which minimizes penetration into the soft underlying surface, enabling high efficiency operation.

This patent document contains material that is subject to copyright protection. Facsimile reproduction is allowed of the patent document or the patent disclosure as it appears in the Patent and Trademark Office patent file or records as allowed by US patent law, but otherwise all copyright rights are reserved.

### BACKGROUND OF THE INVENTION

1. Field of the Invention

This present invention relates to off-road vehicles, including vehicles for use on un-improved or poor quality road surfaces.

2. Description of the Prior Art

There is currently much concern for agricultural productivity, given the expanding world population. This is further exacerbated by the practice of using feed grain crops for making motor vehicle fuel. It is paramount that we make the best possible use of agricultural resources. One way to do this is to greatly expand irrigation by distributing water on a continental basis. This enlargement of agricultural operations could lead to a need for far more agricultural workers. Hopefully, we can find a way to do this within a legal immigration framework. A good start could be based on a new kind of apparatus that would enhance productivity of workers and make the work into a more attractive activity.

Some kinds of agricultural work are hard, slow, and uncomfortable. It is difficult to find workers and pay them enough to get them to do such tasks. To improve this situation with a machine requires both better productivity and greater comfort of the worker. Productivity has to be better per worker in order to make the cost of the machine affordable. Worker comfort has to be provided to attract worker, but also to enable more effective and sustained performance of tasks. Cost of the machine has to be compatible with expectations for improved productivity. Perhaps of greatest importance is the need for energy efficient operation. The intent is that the wages payable would ultimately increase. Still more fundamental are requirements for worker safety.

Compared with most generally familiar vehicles, agricultural vehicles of the sort that would significantly assist farm workers have significantly different performance requirements, and some of these offer potential for unique new system solutions. The biggest of these is the fact that for manual work, unusually low speed is desirable. Another key difference is that the low seat that would enable workers to reach to the ground would mean that conventional notions of how to stabilize a vehicle are inapplicable; particularly, a wide wheel base is not needed. Furthermore, the low operator riding position means that stability need not be so absolute since a roll over event would not be particularly hazardous; as we would normally think of such events for farm tractors. A design freedom is the fact that the overall length of a vehicle oriented toward row crop work can be quite large, enabling a vehicle and various ancillary equipment configured in a narrow but long train.

We look at the historical background for apparatus of this sort in the vast field of agricultural vehicles. Very little is found in the way of simple machines to enable hand work in the fields. Rather, the tendency seems to be to develop tractor based solutions or tractor like systems. Tractors make it possible for some kinds of crops to automate the work and to provide very comfortable cab conditions. For some types of crops this leads to very successful operations utilizing ever larger tractors and harvesters of many types. However, the present need seems to call for different approaches. In many situations, the needed work can simply can not be done from a large vehicle because of the need for hand work close to the ground or for workers to be in positions relative to growing crops that would be awkward from large vehicles. Large vehicles are often not desirable because the crops themselves interfere with access by such vehicles, and unfortunately, this can lead to farming methods where crop spacing does not make the best possible use of land resources, simply because land must be reserved to allow for the vehicle to pass.

U.S. Pat. No. 3,589,744 Hansen 1971 illustrates an apparatus intended to function as an aid to workers. This seems well suited for row crop work.

Less satisfactory is a situation where the vehicle prevents crop spacing that would make the best use of land resources is shown in U.S. Pat. No. 3,546,856 Hiyama 1970, FIG. 2. Somewhat better, but still intrusive is the apparatus of U.S. Pat. No. 4,250,700 Horn et al. 1981. A farming system where it is desirable to enable both the worker and vehicle to pass under growing crop vines as illustrated by the U.S. Pat. No. 3,546,856 Hiyama 1970, FIG. 1 and U.S. Pat. No. 5,423,166 Scott 1995, thus showing the disadvantages of vehicles of the size range usually found in farm vehicles. Further, U.S. Pat. No. 5,423,166 Scott 1995 illustrates the intrusiveness of both grape acquisition machinery and the associated trailer by which harvested grapes are collected.

Many vehicle configurations have been invented with these purposes in mind. Many tend to be constrained to conventional ways of thinking about tractors, farm vehicles that already exist, and about automobiles. Though the invention U.S. Pat. No. 3,589,744 Hansen 1971 seems to be useful, it is complicated. Conventional wheels with balloon type tires mounted are arranged in a three point stabilizing form, generally like many farm tractors, but also harking back to the three wheeled Morgan roadster of long ago. This is adapted to working on low growing crops with over-arching structure that allows passing over crop rows, but all this leads to complicated equipment, when simplicity is needed to allow inexpensive construction. Still this invention by Hansen is successful in providing a low seat for a worker that enables low crop access, all the way to ground level. Hansen shows one wheel that is relatively large which would help hold down drag when traversing over soft earth, but this of course does not indicate an attempt to use this for stability. Reduced width and low seating is shown in U.S. Pat. No. 2,583,358 Cesan 1952, though this offers only a partially effective capability to operate in soft dirt, and width is wider than desired for efficient operation.

Continuous track vehicles serve to enable operation on soft dirt. A wide variation of such a track would offer lateral stability to prevent roll over, should it be used for that purpose, and the included wheels with the track could provide a wide wheel base if needed. The wide range of use of tracked vehicles in agriculture is represented by U.S. Pat. No. 1,376,649 Schneider 1921 and U.S. Pat. No. 4,683,969 Littau 1987. U.S. Pat. No. 7,543,664 Nelson 2009 shows a rubber version, and though this is not indicated, this could be adapted to provide stability as well as load spreading benefits. Generally, vehicles using tracked wheel systems arrange for the tracks to act in widely spaced pairs to provide stability. Rubber forms of tracked systems are used in snow-mobiles, where the track acts to provide stabilization.

Comparing again to U.S. Pat. No. 3,589,744 Hansen 1971, a simpler vehicle would be the recumbent bicycle as illustrated with a sidecar in U.S. Pat. No. 6,565,106 Lopez 2003. With or without a motor or engine this at least shows the basic simplicity needed. A tricycle form of this recumbent bicycle is an obvious variation that can be occasionally seen in use, but this would be still quite useless for the present purpose given that these wheels, though large in diameter, are narrow such that they would sink in soft dirt and cause much resistance to vehicle movement. The obvious tricycle form often includes wide, laterally spaced wheel sets; significantly wider than what would be desired for carrying a worker between narrowly spaced rows.

A very simple aid to workers would be the wheeled stool of U.S. Pat. No. 3,614,120 Cicero 1971 where a seat is provided with a seat back at a slanted position that would make low work more comfortable. This invention shows wide wheels but these are shown as they are mostly for convenience, as they are indicated to be typical rubber balloon tires. Stability for this “Chair Cycle” depends on the use of the legs and feet of the worker, not a lot differently from the way one legged milk stools were stabilized by the user.

One impediment to progress is the widely used rubber, balloon, tractor tire such as indicated in U.S. Pat. No. 3,589,744 Hansen 1971. This works fine where there is a pair of widely spaced wheels that achieves stability, but by itself offers no resistance to rolling sidewise. But wide spacing is exactly what we are not looking for, in order to accomplish the present purposes for enabling more effective crop work.

Curiously, tractor tires of the 1920s utilized hard steel wheels with large spikes bolted to them, where these spikes were called lugs. Because the typical farmer used regular roadways to get tractors from field to field, these lugs caused much disruption of smooth road surfaces. All this went away with inflated rubber tires of the mentioned balloon type. Lugs might not matter to stability, and they could be advantageous in a low speed vehicle.

Searching for solid wheels that would improve stability with a narrow wheelbase turned up U.S. Pat. No. 1,210,056 Fairman 1916 where a narrow vehicle is fitted with hard wheels. This vehicle is questionable as to safety given the high seat position, and of course this configuration does not suggest any interest in enabling hand work on low crops. A tractor utilizing hard wheels configured of lateral slats overlaid with slanted gripping ridges is shown in U.S. Pat. No. 2,560,384 Crain 1951. Though far from the field of farm vehicles, a relevant solid drum wheel is shown in the baby carriage for use in soft dirt of U.S. Pat. No. 5,158,319 Norcia et al. 1992, though there is no low seat for farm work and no special stabilizing purpose involved other than that of conventional baby carriage wheels.

U.S. Pat. No. 6,752,228 Aoyama 2004 reminds us of a function of agricultural vehicles depending on existence of tow bar capabilities, but it also illustrates the difficulty that is encountered in making the seat position truly low. This particular invention is announced as one that enables a low profile operation.

### SUMMARY OF THE INVENTION

Extracting fragments and general ideas from past machine practice led to invention of a simple farm vehicle to support manual work. It would be particularly useful for work on low growing crops. A low seating position is provided for a worker and the lateral dimension is small to enable fitting through narrow spaces such as narrowly spaced crop rows, but elongated to enable needed functions.

The vehicle includes a frame with an attached wheel set and an attached seat for a worker that enables the worker to ride facing generally in the forward direction of travel. The entire vehicle is approximately the width of that seated worker. Within such narrow width confines, the wheel set is configured for both stability and efficiency in dirt.

Adequate stabilization generally excludes the use of wide balloon tires, such as commonly used as the rear tractor tires, having a rounded profile of the tire casing, since these offer little stability beyond slight stiffness of their sidewalls. Instead, wheels systems that have hard outer edges are utilized here, such that a relatively flat lateral surface makes contact with the soft ground.

Energy efficiency for a wheel rolling in dirt comes from minimized pressure on the ground due to a large contact surface achieved with lateral width and maximum practical diameter. Thus there is minimal required traction force, even where some significant load is carried.

Benefits are significant. The very low seat height, that just enables ground clearance, means that the requirement for stability is somewhat lessened, since a roll over event would not be particularly serious; this being the case given that falling would be from that very low position. Unlike with most vehicles, low speed operation greatly reduces hazards of vehicle operation, and absolute stability is not vital.

A myriad of uses would require ancillary equipment of an extent like that available for use with farm tractors and specialty harvesting machines now. These are represented by the prior art discussed here, and the suggestions garnered from these, as well as the implementation details offered there, are incorporated by reference into the present disclosure. Low growing row crops, vineyards, orchards are examples of the range of crop types anticipated, where a much less obtrusive vehicle can be used to advantage. Completely new harvester systems are indicated.

### BRIEF DESCRIPTION OF THE DRAWINGS

FIG. 1 Agricultural vehicle working in field of row crops

FIG. 2 Agricultural vehicle detail

FIG. 3 Motor and control detail shown

FIG. 4 Seat height variation shown

FIG. 5 Vineyard application as representative of wide agricultural applicability

FIG. 6 A drum wheel constructed of light gauge steel with slats for strengthening and tread purposes

FIG. 7 A recumbent vehicle for operation on soft surfaces

FIG. 8 A tracked wheel assembly as variation of the drum wheel concept

FIG. 9 A multiple coaxial wheel assembly variation of the drum wheel concept

### DETAILED DESCRIPTION

The simplest embodiment of this invention is first described, but as many applications of farm tractors are considered, the variations in form and ancillary equipment evolve significantly. All such applications would be expansions on the basic invented concept. Other applications hitherto not related to operation of farm tractors also have emerged, and others are expected. The intention here is to show the scope of the invention by mention of variations and adaptations.

The invention here was done based on generally known apparatus most of which was known prior to reference to the patent literature described in the background section previously included here. However, the background art clearly shows limited extension of industrial technology to the agricultural world to provide what could be important changes in agricultural practice. Thus that practice carries on inadequately, seemingly unaware that industrial approaches could minimize the difficulty and discomfort of the work, not to mention what such approaches could do to enhance productivity of both workers and land.

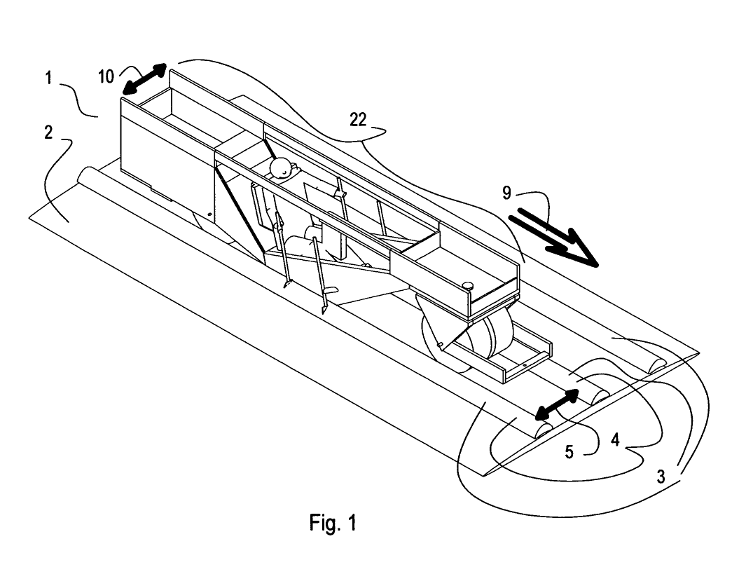

FIG. 1 shows an embodiment of the invented vehicle for utilization in row crop work as an example application. Narrow vehicle 1 operates on soft surface field 2 planted with rows of plants 3. Vehicle 1 is of width 10 to fit between rows 4 spaced a distance 5 to enable best use of field 2. Forward motion is indicated by the arrow 9.

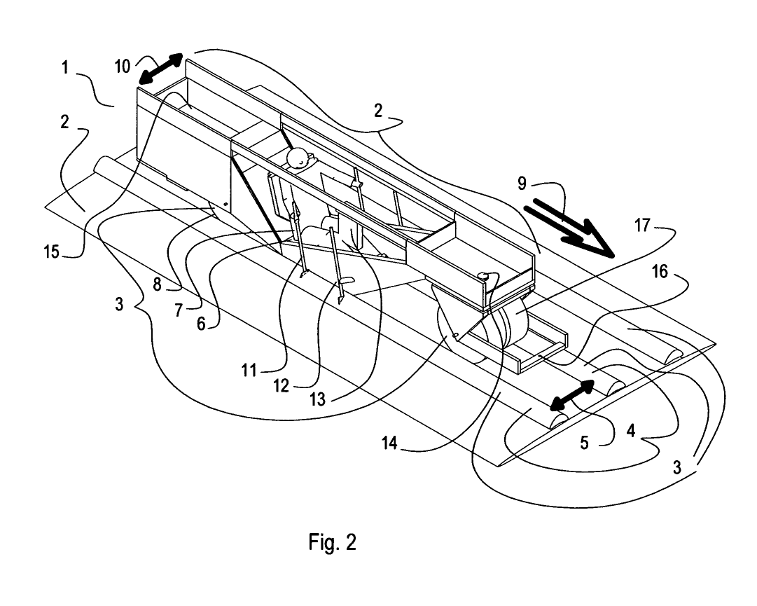

FIG. 2 illustrates the configuration of this embodiment which includes frame 22, wheel set 3, seat 6 adapted to enable work functions of a worker, that worker being represented by placeholder for worker 7. A wide wheel base is established due to outer edge 8 of rear wheel assembly of wheel set 3. Forward direction is indicated by an arrow 9. Vehicle width 10 is approximately the width needed to accommodate the worker and also is approximately the same as the width of the rear wheel assembly of wheel set 3. A split front wheel assembly 17 is shown under pivot assembly 14 and front wheel assembly is controllable by the worker activating a tiller with a knee paddle 13. The split front wheel 17 eases skidding as this wheel is caused to pivot. The front wheel assembly is maximized in width, consistent with turning function that is effective in the row width. A hand tool 11 enables detail work and a mounted tilling tool 12 enables cultivation of a crop as is commonly done with tools mounted on tractors. A capability to carry a harvest is shown by container 15 carried at the rear. A hitch point 16 is shown attached to the front whereby it causes the split front wheel 17 to track the towing vehicle without excess skidding.

The rear wheel assembly of the wheel set 3 is here implemented as a single drum for purposes of achieving ultimate simplicity and enabling low cost construction. Because of the fundamentally narrow form, the skidding that otherwise necessitates a differential to enable differing rate of rear wheels in turns, is much reduced. A combination of steel and plywood is anticipated to provide durability of steel as needed but light weight of plywood when it is sufficient for the purpose intended.

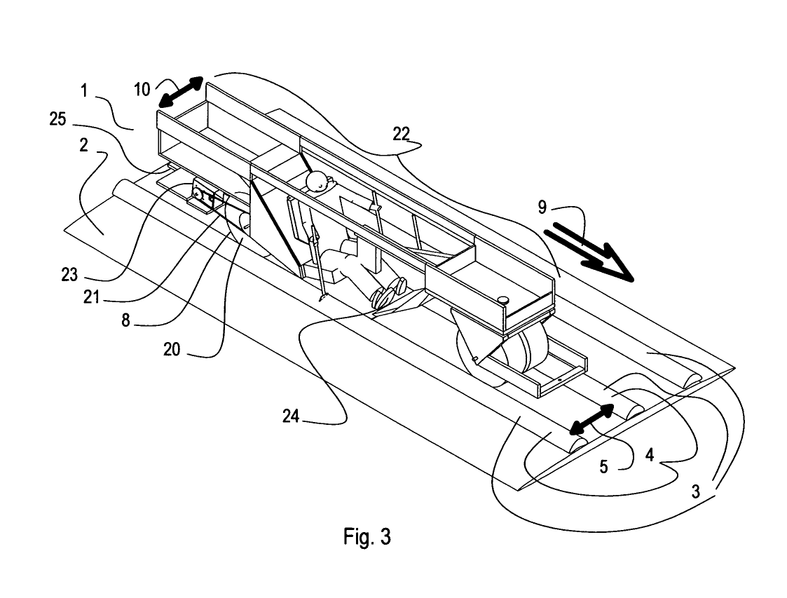

FIG. 3 shows the vehicle with side panels removed to show an electric motor 23 and drive chain or belt 21 and a better view of the rear wheel assembly 20, and particularly, the outer rim 8 of that assembly 20. It also shows a foot control 24, to enable responsive control by a worker, where that control would work through mechanical coupling to electrical controller means. The electric motor 23 is representative of many possible powering systems which would be utilized in various applications. Fuel burning engines are appropriate in some applications, and such are also useable in combination with electric motors. At the rear there is a hitch attaching point 25 that functions like a tractor draw-bar. In large agriculture settings it is intended that a number of such vehicles would be towed in a train out to a field by a large tractor or such more common vehicle.

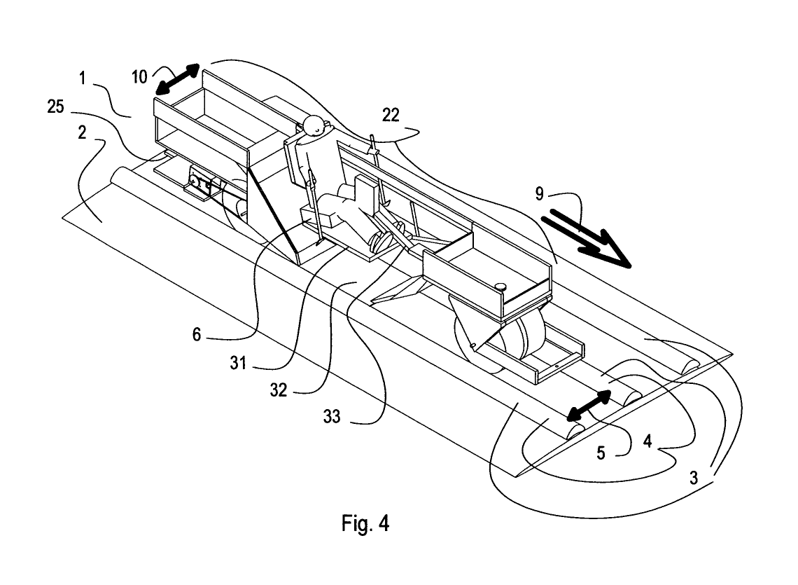

FIG. 4 shows flexibility for varying agriculture operations where the seat 6 is equipped to move with a platform 31 that operates by a mechanism that hoists it above a vehicle floor pan 32. The tiller 33 that controls pivoting of the front wheel assembly is shown in hinged position to accommodate the higher operating position.

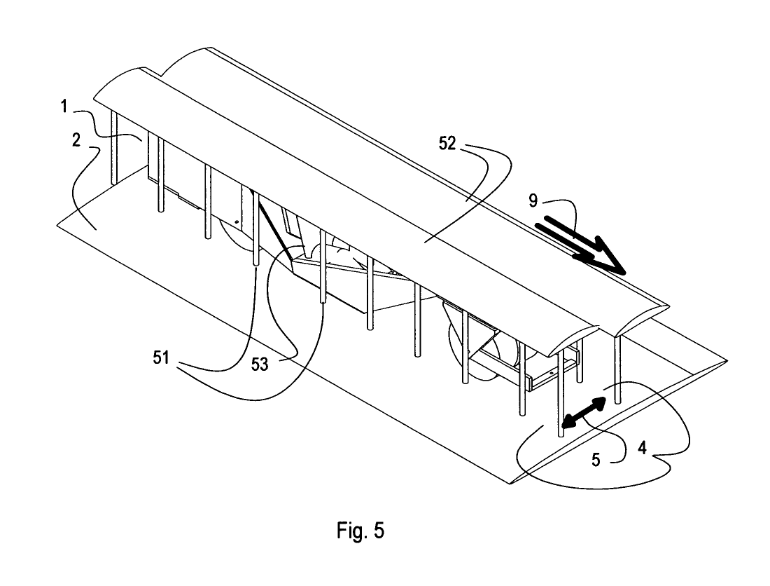

In FIG. 5, vineyard operations are shown schematically to show generalized applicability of the invention. Here vines grow from parallel rows 4 as before with trunk parts 51 supporting overhead vine canopy 52. Narrow vehicle 1 travels between rows 4 as before, but here the skill of a worker, who is indicated by placeholder 53, is enabled for careful harvest of grapes. Mechanized harvesting, similar to that done by machines by Gregoire Company, is a further means of adaptation to agricultural operations which is enabled by attachment of such, to the invented low vehicle.

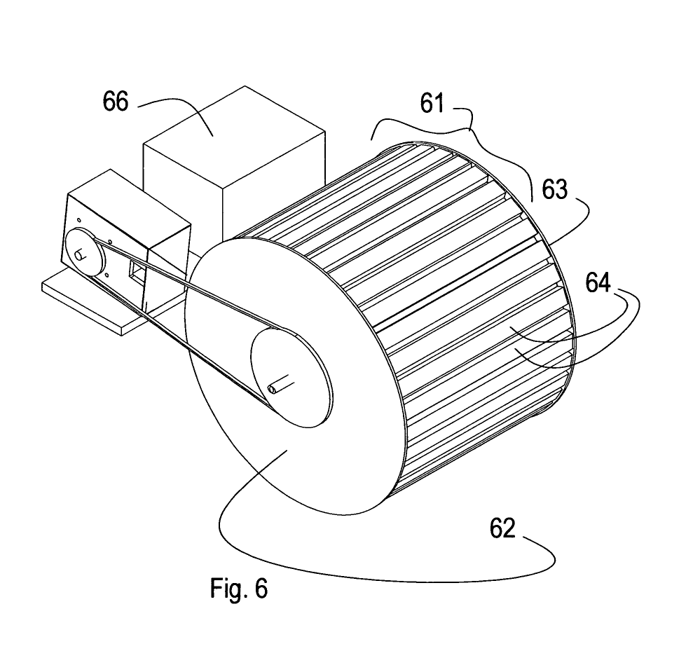

FIG. 6 shows the construction of a drum wheel which would be particularly appropriate as the rear wheel of the wheel set for a vehicle described here, or any vehicle that needs to function efficiently in soft earth. It is based on a drum form which is a simple cylindrical surface 61 with planar end caps 62. These end caps extend beyond the drum diameter to act as a flange 63 which provides a ridge which provides some lateral grip. The flange 63 also provides a mounting point for lateral slats 64 that provide reinforcing for the drum and also serve as a tread. The flange 63 also acts to minimize clatter of the slats in cases where a rolling on a hard surface is involved. Slats can be mounted with a skew angle and may be in separate segments across the drum surface. Simple slats 64 are wood with a rubber layer on the surface. A rubber rim is also set on the outer edge of the flange 63.

FIG. 6 also illustrates the battery box 65 needed with the electric motor, and the appropriate controller is assumed also to be therein. The controller is linked to the operator control by appropriate mechanical and electronic means which is not detailed, but is well with the art of mechanical and circuit design engineering.

And of course such drums are not limited to running on an earth surface, so this represents an adaptation for whatever uses might be desired for an apparatus according to this invention. The large diameter, wide wheel offers a larger footprint area which minimizes sinking into any soft surface. A snowmobile application is a good example.

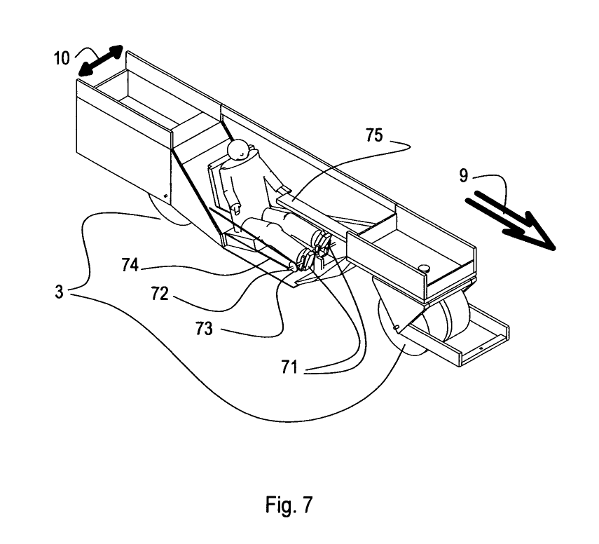

FIG. 7 illustrates the simplest form of the invention, where it is reduces to a manually driven recumbent bicycle, though still utilizing the large contact area and wide stabilizing width of the drum wheel system 3. A side panel and top brace are removed here to show how pedals 71 drive a crankshaft 72 which drives a sprocket 73; then a chain 74 which drives the rear wheel as the motor system did in the earlier illustrations. Gearing is implied but not shown, where this could enable very low speed operation. The tiller steering 75 simply represents a wide variety of known possibilities. This apparatus achieves substantial stability even though it is quite narrow. In fact, it would be capable of stationary position holding, which could lead to a variety of activities of value. And of course, it has the capability of running on soft surfaces. The very inexpensive implementation here shown might represent a very useful tool for agricultural work, improving the quality in many respects, though not offering the power driven advantages.

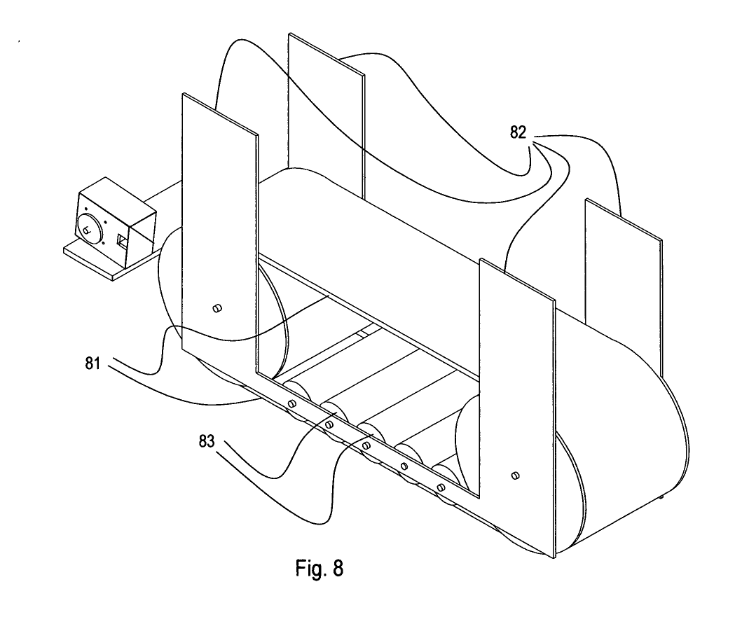

FIG. 8 shows a tracked wheel assembly that would act as an alternative to the drum wheel assembly 20 of FIG. 3 that would be particularly useful in very soft terrain. The same electric motor 23 is shown to give perspective. The tracked wheel assembly would require lengthening of the vehicle 1 of FIG. 1 since it is a longer rear wheel assembly than the drum. Structural parts 82 hold the wheel assembly and serve to couple to the overall vehicle frame. The continuous track 81 is laid down and less wide small wheels 83 ride on the track 81. The less wide small wheels 83 are encircled by the continuous track 81. In this operation, the less wide small wheels 83 are not the final stabilizing outer edges since the governing outer edges are set by the outer edges of the track 81, since the track itself offers lateral rigidity.

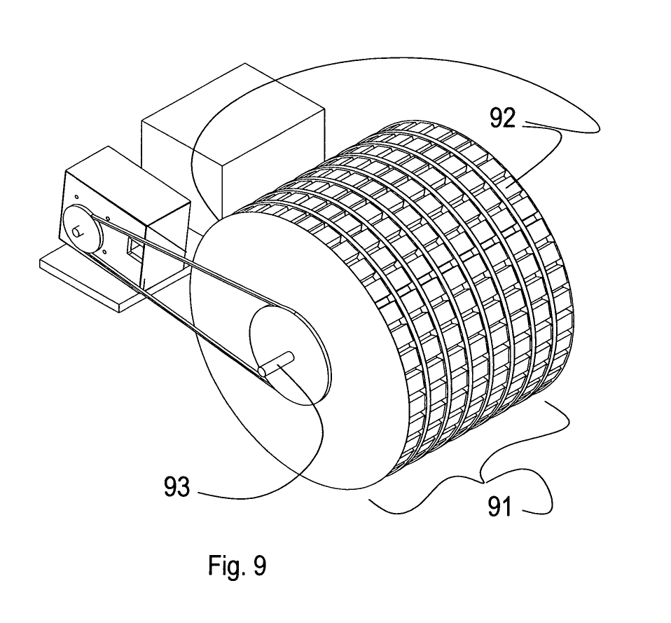

FIG. 9 shows a functional equivalent to the drum wheel assembly 20 of FIG. 3. Here there are multiple, coaxially mounted, thin wheels 91 that serve to spread the load on soft surfaces. The common axle 93 enables mounting, much as did the drum axle. The outer wheels 92 of the set of thin wheels 91 provide the governing width for establishing roll stability. An implementation of this thin wheel set can be achieved with thin wheels of the more conventional balloon rubber tire sort, but by this arrangement, the instability of a single balloon tire can be avoided.

Further invention disclosures are planned which would cover variations of the basic concept here disclosed, as well as various related types of special harvesting equipment and other farm operation aids. Suggestions are available from the prior art discussed in the background of this present document.

The scope of the invention is to be defined by the appended claims.

I claim:

1. A narrow vehicle for agricultural work that includes a frame with an attached set of wheels and an attached seat for a farm worker, where base of said seat is carried low to enable said worker to ride as low to the ground as possible, where said seat enables said worker to ride facing in the direction of forward vehicle motion, where said set of wheels includes a wide wheel set that is confined within a vehicle width that is approximately that of said worker thus seated, where said wide wheel set provides maximized ground area support and provides stabilization according to width of outer edges of said wide wheel set, where said stabilization acts to prevent roll over of said narrow vehicle.

2. A narrow vehicle according to claim 1, where said wide wheel set includes a wide drum wheel, whereby operation on soft earth could occur with minimum depression into said soft earth, thus minimizing force required to move said vehicle.

3. A narrow vehicle according to claim 1 where said set of wheels includes a wide drum wheel is configured with lateral slats that are mounted on a said drum wheel about its circumference.

4. A narrow vehicle according to claim 1 that is a low speed vehicle suited for use in manual agricultural work.

6. A narrow vehicle according to claim 1, where said wide wheel set includes a wide drum wheel whereby operation on soft earth could occur with minimum depression into said soft earth, thus minimizing force required to move said vehicle, and said wide drum wheel includes lateral slats that form a cylindrical shape that is said wide drum wheel.

7. A narrow vehicle according to claim 1 where said wide wheel set includes a tracked wheel set that includes a continuous track that is laid down for track encircled wheels to run on, such that said encircled wheels are held away from soft surfaces, where said continuous track is laterally rigid such that provides said stabilization to outer edges of said continuous track.

8. A narrow vehicle according to claim 1 that utilizes energy from a source other than a human source.

9. A narrow vehicle according to claim 1 where said wide wheel set is an assembly that includes multiple, thin wheels mounted coaxially.

10. A narrow vehicle according to claim 1 that is fitted with ancillary equipment related to cultivation of row crops.

11. A narrow vehicle according to claim 1 adapted for cultivation of row crops, where crops are planted in parallel rows, and said vehicle width enables narrow row spacing.

12. A narrow vehicle according to claim 1 that is adapted for cultivation of vineyards.

13. A narrow vehicle according to claim 1 that is adapted for cultivation of vineyards, where low seating of said worker enables work under a vine canopy, where said narrow vehicle is configured to carry said worker.

14. A narrow vehicle according to claim 1 that is adapted for cultivation of vineyards, where said narrow vehicle width enables higher density of plants than would be possible if conventional tractors were to be utilized in said cultivation.

15. A narrow vehicle according to claim 1 that is adapted for harvesting of vineyards, where low seating of said worker enables a configuration of said narrow vehicle that enables operation of said narrow vehicle under a vine canopy.

16. A narrow vehicle according to claim 1 that is adapted for harvesting of vineyards, where said narrow vehicle has a width that enables higher density of plants than would be possible if conventional tractors were to be utilized in said cultivation.

17. A narrow vehicle according to claim 1 where said stabilization is sufficient to enable a stable stationary stance.

18. A narrow vehicle according to claim 1 where said stabilization is sufficient to enable stable low speed operation.

19. A narrow vehicle according to claim 1 where said wide wheel set includes an assembly of coaxially mounted wheels such that outer wheels of said assembly determine roll stability of said narrow vehicle.

20. A narrow vehicle according to claim 1 where said seat is at a height suited for a particular application.

21. A narrow vehicle according to claim 1 and apparatus to enable height adjustment of said seat.

22. A recumbent vehicle according to the general form of a recumbent bicycle and its many mechanized and propelled variations, where said recumbent vehicle is fitted with a wide drum wheel whereby operation on soft surfaces would be enabled.

23. A vehicle according to claim 22 where said wide drum wheel is configured with lateral slats that are mounted on a said drum wheel about its circumference.

24. A vehicle according to claim 22 where said wide drum wheel is configured with lateral slats that are mounted on a said drum wheel about its circumference, where said lateral slats are wood.

25. A vehicle according to claim 22 where said wide drum wheel is configured with lateral slats that are mounted on a said drum wheel about its circumference.

26. A vehicle according to claim 22 where said wide drum wheel is configured with lateral slats that are mounted on a said drum wheel about its circumference, where said drum wheel includes coaxial discs that enable smooth rolling on hard surfaces.

27. A vehicle according to claim 22 where said wide drum wheel is configured with lateral slats that are mounted on a said drum wheel about its circumference, where said drum wheel includes coaxial discs that are attached at ends of said drum wheel such that loose surface material under slats is held to limit lateral displacement of said loose surface material.

28. A vehicle according to claim 22 that is fitted with apparatus to enable motorized propulsion.

29. A vehicle according to claim 22 that is fitted with apparatus for engine propulsion.

30. A vehicle according to claim 22 that is a snow bicycle that is fitted with pedals to enable manual propulsion.

31. A recumbent vehicle according to claim 22 where said wide drum wheel enables stability for low speed operation.

32. A recumbent vehicle according to claim 22 where said wide drum wheel enables stability in a static condition of operation.

33. A narrow snow-mobile of width equal approximately to that of a single seated person, that is equipped with a wide wheel set of width approximately that of a single seated person, where stability is provided by said wheel set, and said wide wheel set provides a stabilizing stance that is determined by the outer edges of said wheel set.
